(19) United States
(12) Patent Application Publication
(10) Pub. No.: US 2024/0002106 A1
(43) Pub. Date: Jan. 4, 2024

(54) Wet Paint Roller Pad Preserver

(71) Applicant: Anthony Berg, Byron, IL (US)

(72) Inventor: Anthony Berg, Byron, IL (US)

(21) Appl. No.: 18/331,451

(22) Filed: Jun. 8, 2023

Related U.S. Application Data
(60) Provisional application No. 63/357,198, filed on Jun. 30, 2022.

(51) Int. Cl. B65D 33/25; B65D 33/00; B65B 5/04

(52) U.S. Cl. CPC B65D 33/25; B65B 5/045; B65D 33/004

(57) ABSTRACT

A paint roller pad storage device is disclosed as a specialized plastic bag for keeping a paint roller pad wet over the course of multiple days. The bag helps preserve the paint and prevent the roller pad from drying out. The paint roller pad storage device comprises a body component with opposing ends. One end is open for receiving the wet paint roller pad and the opposing end is sealed closed to prevent excessive air leaks. The body component would measure approximately 5 inches by 18 inches and would have a bag volume of approximately 0.65 ml to 0.75 ml.

### CROSS-REFERENCE TO RELATED APPLICATION

The present application claims priority to, and the benefit of, U.S. Provisional Application No. 63/357,198, which was filed on Jun. 30, 2022, and is incorporated herein by reference in its entirety.

### FIELD OF THE INVENTION

The present invention relates generally to the field of paint roller pad storage devices. More specifically, the present invention relates to a protective bag covering for wet paint roller pads capable of preserving paint for additional use. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in paint roller pad storage devices. Generally, after a user is finished painting with a wet paint roller, he/she is forced to fully clean the roller so it can be reused. Paint is essentially wasted once it is washed from the roller pad. Alternatively, unwashed roller pads dry out quickly and are rendered unusable. If a wet paint roller pad is left on the roller handle and covered with a plastic bag, it can still dry out and stick to the handle. Thus, the paint roller pad still dries out and must be thrown away due to dry, caked on paint.

Generally, a paint roller includes a handle and a removable paint roller pad which receives paint for application to a surface. Typically, the paint roller pad is cleaned which may be a relatively time-consuming process. Oftentimes, the paint roller pad is discarded after usage.

Disadvantageously, discarding the paint roller pad may be relatively expensive. Further, as paint rollers are typically utilized for relatively large surface areas, it is quite common to paint in multiple sessions, perhaps over multiple of days. Even when taking a break from painting, a paint-wet paint roller pad may be rendered unusable by paint drying thereon. Additionally, cleaning the paint roller pad for such short breaks is typically more trouble than simply discarding the paint roller pad.

Accordingly, it is desirable to provide a storage device for a paint roller pad which permits storage of a paint-wet paint roller pad for relatively short time periods without the necessity of cleaning. More particularly, there is a demand for a resealable storage bag for a paint roller pad.

Therefore, there exists a long-felt need in the art for a paint roller pad storage device that provides users with a protective bag covering for wet paint roller pads capable of preserving paint for additional use. There is also a long-felt need in the art for a paint roller pad storage device that allows the wet roller pad to be firmly sealed inside the covering, preventing any air leaks and maintaining the integrity of the paint. Further, there is a long-felt need in the art for a paint roller pad storage device that enables users to simply slide the wet roller pad from the roller handle and secure it inside the bag with ease. Moreover, there is a long-felt need in the art for a device that eliminates the need to clean paint roller pads after each use and waste excessive paint. Further, there is a long-felt need in the art for a paint roller pad storage device that is disposable after use. Finally, there is a long-felt need in the art for a paint roller pad storage device that stores the wet paint roller pad securely for multiple days.

The subject matter disclosed and claimed herein, in one embodiment thereof, comprises a paint roller pad storage device. The device is a specialized plastic bag for keeping a paint roller pad wet over the course of multiple days. The bag helps preserve the paint and prevent the roller pad from drying out. The paint roller pad storage device comprises a body component with opposing ends. One end is open for receiving the wet paint roller pad and the opposing end is sealed closed to prevent excessive air leaks. The body component would measure approximately 5 inches by 18 inches and would have a bag volume of approximately 0.65 ml to 0.75 ml.

In use, when the painter is finished painting, he/she can slide the paint roller pad storage device over the wet paint roller pad. The roller handle is then removed from the roller, and the open end of the body component is tucked into the top of the wet paint roller pad, sealing the device around the paint roller pad. The device and paint roller pad can be stored in a safe space for eventual reuse of the paint roller pad.

In this manner, the paint roller pad storage device of the present invention accomplishes all of the foregoing objectives and provides users with a device that provides a protective bag for wet paint roller pads. The device is a transparent, plastic bag configured to retain a conventional paint roller pad. The device can be disposable.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wet paint roller pad storage device. The device is a specialized plastic bag for keeping a paint roller pad wet over the course of multiple days. The bag helps preserve the paint and prevents the roller pad from drying out. The paint roller pad storage device comprises a body component with opposing ends. One end is open for receiving the wet paint roller pad and the opposing end is sealed closed to prevent excessive air leaks.

In use, when the painter is finished painting, he/she can slide the paint roller pad storage device over the wet paint roller pad. The roller handle is then removed from the roller, and the open end of the body component is tucked into the top of the wet paint roller pad sealing the device around the paint roller pad. The device and paint roller pad can be stored in a safe space for eventual reuse of the paint roller pad.

In one embodiment, the paint roller utilized with the device includes a handle which supports the paint roller. The handle receives a removable paint roller pad which is typically a tubular member with various surfaces which retains a quantity of paint for application to a surface.

In one embodiment, the paint roller pad storage device comprises a paint roller cover sized to store a single paint roller pad. The paint roller pad storage device is resealable and selectively encloses the paint roller pad to form a generally airtight environment for the single paint roller pad. The present invention therefore provides a means for storage of the paint roller pad which permits storage of a paint-wet paint roller pad for relatively short time periods without the necessity of cleaning.

Generally, the paint roller pad storage device consists of a typical clear plastic bag used to cover a paint roller pad. This bag would be sized to fit easily over the paint roller pad. In one embodiment, the paint roller pad storage device is manufactured of polyethylene, PVC, ABS, etc., or any other suitable plastic material as is known in the art. The bag seals the paint roller pad inside. The sealed bag prevents the paint on the paint roller pad from drying out during a break in the painting process, such as a lunch break or when painting the same color the next day. Thus, the need to wash out the paint roller pad in these situations is eliminated, saving time and mess.

In one embodiment, the paint roller pad storage device comprises a body component with opposing ends. The body component is flexible, pliable, and easily placed around a paint roller pad. The first end of the opposing ends is open for receiving the wet paint roller pad and the second end of the opposing ends is sealed closed to prevent excessive air leaks.

In one embodiment, the paint roller pad storage device is preferably an elongated plastic bag which is generally rectilinear in shape. Alternatively, the paint roller pad storage device includes a circular closed bottom opposite the resealable closure of the open end, such that the paint roller pad storage device closely fits over the cylindrical paint roller pad.

In one embodiment, the body component would measure approximately 5 inches by 18 inches and would have a bag volume of approximately 0.65 ml to 0.75 ml but can be any suitable size and shape as is known in the art, as long as it is sized to retain a conventional paint roller pad.

In one embodiment, the paint roller pad storage device comprises a resealable closure that selectively closes the paint roller pad storage device and creates a generally airtight environment for a single paint roller pad. The resealable closure is shaped and sized to be folded or tucked into a top of the paint roller pad to seal the paint roller pad within the device. In another embodiment, the open end comprises an adhesive flap or a zip-lock type closure, or any other suitable securing means.

Generally, the paint roller pad storage device is shaped and sized, such that the paint roller pad is readily inserted therein without requiring a user to touch the paint-wet paint roller pad. In use, the paint-wet paint roller pad is inserted into the paint roller pad storage device and sealed therein by tucking the open end into a top of the paint roller pad or via the resealable closure. As the paint roller pad storage device creates a generally airtight environment, the paint-wet paint roller pad may be stored, such as overnight, until further painting will occur.

Such an arrangement greatly facilitates painting without the waste associated with disposing of a paint-wet paint roller pad or the significant time required to clean the wet paint from the paint roller pad. The paint roller pad storage device, being a generally flexible bag, also permits grasping of the paint-wet paint roller pad after the paint roller pad storage device is installed thereon to facilitate removal of the paint-wet paint roller pad from the paint roller.

In one embodiment, the paint roller pad storage device is sized to store the paint roller pad. Notably, multiple paint roller pad storage devices of identical size, are storable within a device container.

Furthermore, by utilizing a paint roller pad storage device container which stores multiple paint roller pad storage devices, the paint roller pad device container may be utilized as part of a kit for selling the paint roller pad storage device. The paint roller pad storage device not only functions as described above for relatively short-term storage of a paint-wet paint roller pad, but because of the inexpensive nature thereof, also operates as an inexpensive long-term storage device of the paint roller pad itself.

Accordingly, the device is best manufactured in a flexible clear plastic material and is provided in different sizes according to the size of the paint roller pad that is placed in it. Generally, the devices would be disposable. The device would also be available in sets that have several different sizes, individually sold in one size, or multiple bags of one size would be available in pre-packaged containers.

In use, a paint-wet paint roller pad is inserted into the paint roller pad storage device and sealed therein by the resealable closure or by being tucked into the top of the paint roller pad. As the paint roller pad storage device creates a generally airtight environment, the paint-wet paint roller pad may be stored, such as overnight, until further painting will occur. Such an arrangement greatly facilitates painting without the waste associated with disposing of a paint-wet paint roller pad or the laborious and time-consuming process required to clean the wet paint from the paint roller pad. The paint roller pad storage device being flexible, permits grasping of the paint-wet paint roller pad after the paint roller pad storage device is installed to facilitate removal of the paint-wet paint roller pad from the roller.

In yet another embodiment, the paint roller pad storage device comprises a plurality of indicia.

In yet another embodiment, a method of storing and protecting a wet paint roller pad for additional use is disclosed. The method includes the steps of providing a paint roller pad storage device comprising a body component with opposing ends, wherein one end is open, and the other end is sealed closed. The method also comprises opening the device and inserting a wet paint roller pad into the body component via the open end. Further, the method comprises removing the handle from the paint roller. The method comprises securing the open end of the body component into the top of the wet paint roller pad, sealing the device around the paint roller pad. Finally, the method comprises storing the device and the paint roller pad in a safe space for eventual reuse of the paint roller pad.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the paint roller pad storage device of the present invention showing the device along with a conventional paint roller in accordance with the disclosed architecture;

FIG. 2 illustrates a perspective view of one embodiment of the paint roller pad storage device of the present invention showing how the device is slid over the paint roller pad in accordance with the disclosed architecture;

FIG. 3 illustrates a perspective view of one embodiment of the paint roller pad storage device of the present invention showing how once the device is positioned on the paint roller pad, the paint roller pad is removed from the handle in accordance with the disclosed architecture;

FIG. 4 illustrates a perspective view of one embodiment of the paint roller pad storage device of the present invention showing how the device covers the wet paint roller pad and its wet paint in accordance with the disclosed architecture;

FIG. 5 illustrates a perspective view of one embodiment of the paint roller pad storage device of the present invention showing the handle reattached and the device being removed, such that a user can use the paint roller again in accordance with the disclosed architecture; and

FIG. 6 illustrates a flowchart showing the method of storing and protecting a wet paint roller pad for additional use in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a paint roller pad storage device that provides users with a protective bag covering for wet paint roller pads capable of preserving paint for additional use. There is also a long-felt need in the art for a paint roller pad storage device that allows the wet roller pad to be firmly sealed inside the covering, preventing any air leaks and maintaining the integrity of the paint. Further, there is a long-felt need in the art for a paint roller pad storage device that enables users to simply slide the wet roller pad from the roller handle and secure it inside the bag with ease. Moreover, there is a long-felt need in the art for a device that eliminates the need to clean paint roller pads after each use and waste excessive paint. Further, there is a long-felt need in the art for a paint roller pad storage device that is disposable after use. Finally, there is a long-felt need in the art for a paint roller pad storage device that stores the wet paint roller pad securely for multiple days.

The present invention, in one exemplary embodiment, is a novel paint roller pad storage device. The device is a specialized plastic bag for keeping a paint roller pad wet over the course of multiple days. The bag helps preserve the paint and prevents the roller pad from drying out. The paint roller pad storage device comprises a body component with opposing ends. One end is open for receiving the wet paint roller pad and the opposing end is sealed closed to prevent excessive air leaks. The body component would measure approximately 5 inches by 18 inches and would have a bag volume of approximately 0.65 ml to 0.75 ml. The present invention also includes a novel method of storing and protecting a wet paint roller pad for additional use. The method includes the steps of providing a paint roller pad storage device comprising a body component with opposing ends, wherein one end is open, and the other end is sealed closed. The method also comprises opening the device and inserting a wet paint roller pad into the body component via the open end. Further, the method comprises removing the handle from the paint roller. The method comprises securing the open end of the body component into the top of the wet paint roller pad sealing the device around the paint roller pad. Finally, the method comprises storing the device and the paint roller pad in a safe space for eventual reuse of the paint roller pad.

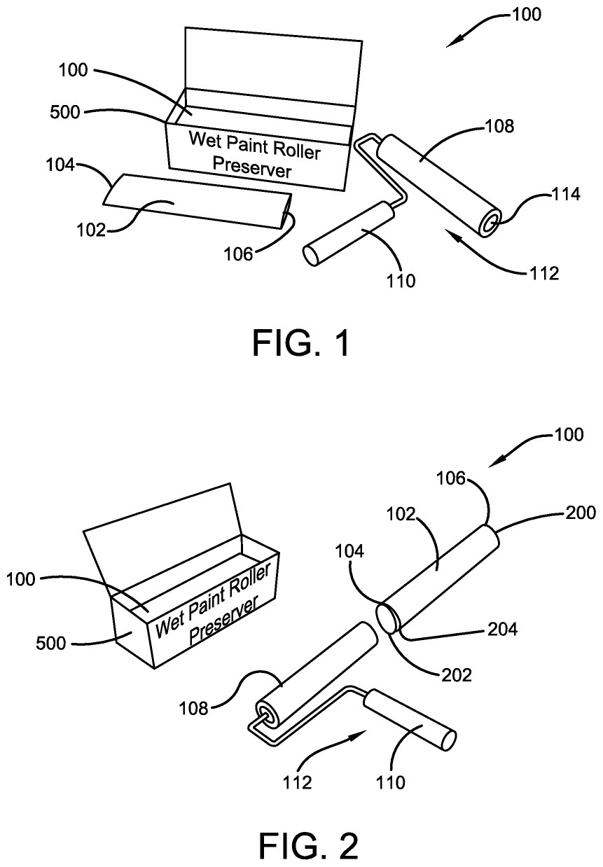

Referring initially to the drawings, FIG. 1 illustrates a perspective view of one embodiment of the paint roller pad storage device 100 of the present invention. In the present embodiment, the paint roller pad storage device 100 is an improved paint roller pad storage device 100 that provides a user with a specialized protective bag for covering a wet paint roller pad 108 capable of preserving the paint for additional use over the course of multiple days. The bag device 100 helps preserve the paint and prevents the roller pad 108 from drying out. Specifically, the paint roller pad storage device 100 comprises a body component 102 with opposing ends, wherein the first end 104 is open for receiving a wet paint roller pad 108 and the second end 106 is sealed closed to prevent excessive air leaks.

In use, when the painter is finished painting, he/she can slide the paint roller pad storage device 100 over the wet paint roller pad 108. The roller handle 110 is then removed from the roller 112, and the open end 104 of the body component 102 is tucked into the top 114 of the wet paint roller pad 108 sealing the device 100 around the paint roller pad 108. The device 100 and paint roller pad 108 can be stored in a safe space for eventual reuse of the paint roller pad 108.

Generally, the paint roller 112 utilized with the device 100 includes a handle 110 which supports the paint roller 112. The handle 110 receives a removable paint roller pad 108 which is typically a tubular member with various surfaces which retains a quantity of paint for application to a surface. The paint rollers 112 can be configured in various sizes and the paint roller pad storage device 100 can be made in different sizes to fit the different sizes of paint rollers 112, as needed.

Overall, the paint roller pad storage device 100 comprises a paint roller cover sized to store a single paint roller pad 108. The paint roller pad storage device 100 is resealable and selectively encloses the paint roller pad 108 to form a generally airtight environment for the single paint roller pad 108. The present invention therefore provides a means for storage of the paint roller pad 108 which permits storage of a paint-wet paint roller pad 108 for relatively short time periods without the necessity of cleaning.

Generally, the paint roller pad storage device 100 consists of a typical clear plastic bag used to cover a paint roller pad 108. This bag would be sized to fit easily over the paint roller pad 108. In one embodiment, the paint roller pad storage device 100 is manufactured of polyethylene, PVC, ABS, etc., or any other suitable plastic material as is known in the art. The bag device 100 seals the paint roller pad 108 inside. The sealed bag device 100 prevents the paint on the paint roller pad 108 from drying out during a break in the painting process, such as a lunch break or when painting the same color the next day. Thus, the need to wash out the paint roller pad 108 in these situations is eliminated, saving time and mess.

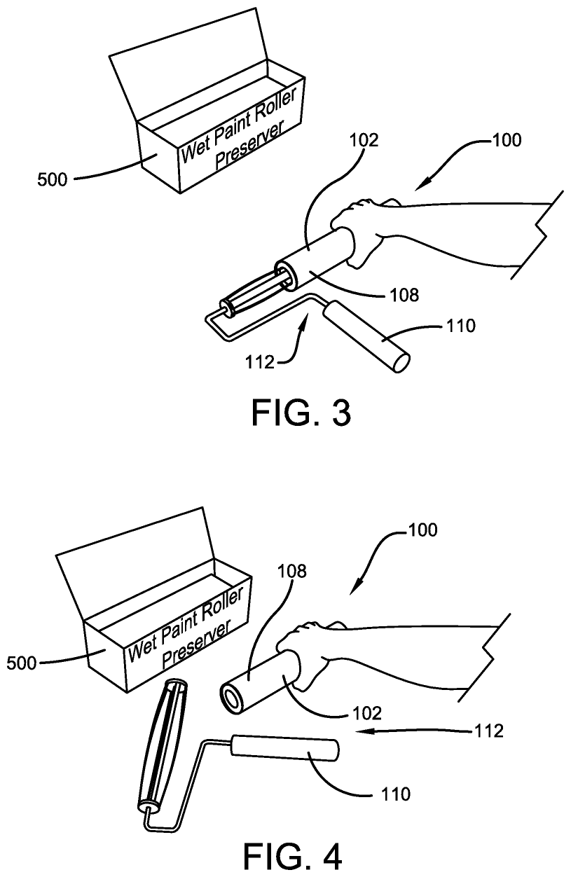

As shown in FIGS. 2-4, the paint roller pad storage device 100 comprises a body component 102 with opposing ends. The body component 102 is flexible and pliable, and easily placed around a paint roller pad 108. The first end 104 of the opposing ends is open for receiving the wet paint roller pad 108 and the second end 106 of the opposing ends is sealed closed to prevent excessive air leaks.

Furthermore, the paint roller pad storage device 100 is preferably an elongated plastic bag which is generally rectilinear in shape. Alternatively, the paint roller pad storage device 100 includes a circular closed bottom 200 opposite the resealable closure of the open end, such that the paint roller pad storage device 100 closely fits over the cylindrical paint roller pad 108. In another embodiment, both opposing ends comprise a circular bottom to more closely fit the cylindrical paint roller pad 108.

Generally, the body component 102 would measure approximately 5 inches by 18 inches and would have a bag volume of approximately 0.65 ml to 0.75 ml but can be any suitable size and shape as is known in the art, as long as it is sized to retain a conventional paint roller pad 108.

Furthermore, the paint roller pad storage device 100 comprises a resealable closure 202 that selectively closes the paint roller pad storage device 100 and creates a generally airtight environment for a single paint roller pad 108. The resealable closure 202 is shaped and sized to be folded or tucked into a top 114 of the paint roller pad 108 to seal the paint roller pad 108 within the device 100. In another embodiment, the open end 104 comprises an adhesive flap or a zip-lock type closure 204, or any other suitable securing means.

Generally, the paint roller pad storage device 100 is shaped and sized, such that the paint roller pad 108 is readily inserted therein without requiring a user to touch the paint-wet paint roller pad 108. In use, the paint-wet paint roller pad 108 is inserted into the paint roller pad storage device 100 and sealed therein by tucking the open end 104 into a top 114 of the paint roller pad 108 or via the resealable closure 202. As the paint roller pad storage device 100 creates a generally airtight environment, the paint-wet paint roller pad 108 may be stored, such as overnight, until further painting will occur.

Such an arrangement greatly facilitates painting without the waste associated with disposing of a paint-wet paint roller pad 108 or the significant time required to clean the wet paint from the paint roller pad 108. The paint roller pad storage device 100, being a generally flexible bag, also permits grasping of the paint-wet paint roller pad 108 after the paint roller pad storage device 100 is installed thereon to facilitate removal of the paint-wet paint roller pad 108 from the paint roller 112.

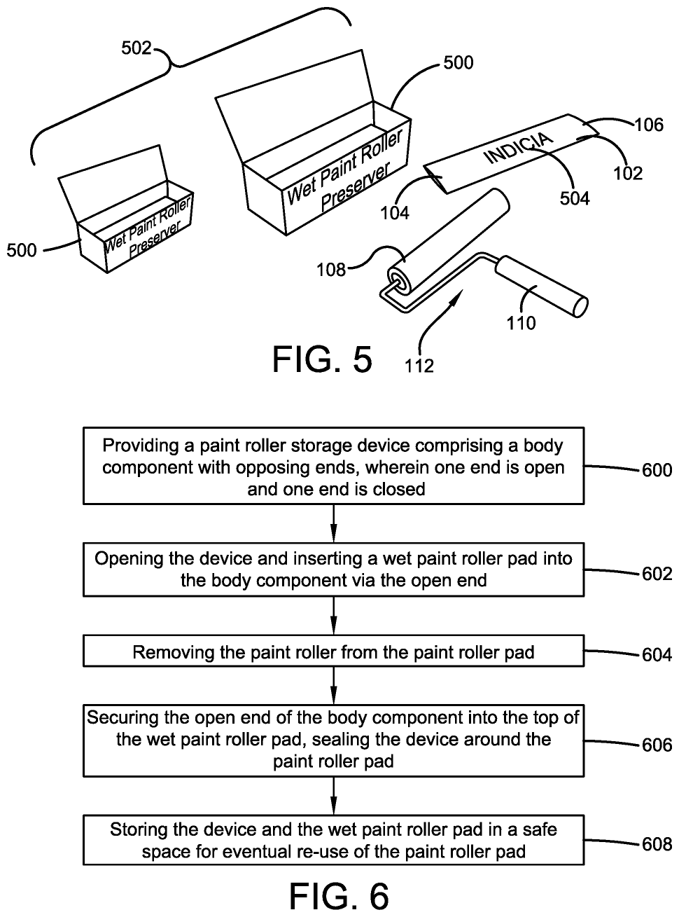

As shown in FIG. 5, the paint roller pad storage device 100 is sized to store the paint roller pad 108. Notably, multiple paint roller pad storage devices 100 of identical size are storable within a device container 500.

Furthermore, by utilizing a paint roller pad storage device container 500 which stores multiple paint roller pad storage devices 100, the paint roller pad device container 500 may be utilized as part of a kit 502 for selling the paint roller pad storage device 100. The paint roller pad storage device 100 not only functions as described above for relatively short-term storage of a paint-wet paint roller pad 108, but because of the inexpensive nature thereof, also operates as an inexpensive long-term storage device of the paint roller pad 108 itself.

Accordingly, the device 100 is best manufactured in a flexible clear plastic material and provided in different sizes according to the size of the paint roller pad 108 that is placed in it. Generally, the devices 100 would be disposable. The device 100 would also be available in sets (or kits 502) that have several different sizes, individually sold in one size, or multiple bags of one size would be available in pre-packaged containers 500.

In use, a paint-wet paint roller pad 108 is inserted into the paint roller pad storage device 100 and sealed therein by the resealable closure 202 or by being tucked into the top 114 of the paint roller pad 108. As the paint roller pad storage device 100 creates a generally airtight environment, the paint-wet paint roller pad 108 may be stored, such as overnight, until further painting will occur. Such an arrangement greatly facilitates painting without the waste associated with disposing of a paint-wet paint roller pad 108 or the laborious and time-consuming process required to clean the wet paint from the paint roller pad 108. The paint roller pad storage device 100 being flexible permits grasping of the paint-wet paint roller pad 108 after the paint roller pad storage device 100 is installed to facilitate removal of the paint-wet paint roller pad 108 from the roller 112.

In yet another embodiment, the paint roller pad storage device 100 comprises a plurality of indicia 504. The body component 102 of the device 100 may include advertising, trademark, other letters, designs, or characters, printed, painted, stamped, or integrated into the body component 102, or any other indicia 504 as is known in the art. Specifically, any suitable indicia 504 as is known in the art can be included, such as, but not limited to, patterns, logos, emblems, images, symbols, designs, letters, words, characters, animals, advertisements, brands, etc., that may or may not be paint, paint roller, or brand related.

FIG. 6 illustrates a flowchart of the method of storing and protecting a wet paint roller pad for additional use. The method includes the steps of at 600, providing a paint roller pad storage device comprising a body component with opposing ends, wherein one end is open, and the other end is sealed closed. The method also comprises at 602, opening the device and inserting a wet paint roller pad into the body component via the open end. Further, the method comprises at 604, removing the paint roller from the paint roller pad. The method comprises at 606, securing the open end of the body component into the top of the wet paint roller pad, sealing the device around the paint roller pad. Finally, the method comprises at 608, storing the device and the paint roller pad in a safe space for eventual reuse of the paint roller pad.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “paint roller pad storage device”, “paint roller pad device”, “storage device”, “bag device”, and “device” are interchangeable and refer to the paint roller pad storage device 100 of the present invention.

Notwithstanding the foregoing, the paint roller pad storage device 100 of the present invention can be of any suitable size and configuration as is known in the art without affecting the overall concept of the invention, provided that it accomplishes the above-stated objectives. One of ordinary skill in the art will appreciate that the paint roller pad storage device 100 as shown in FIGS. 1-6 are for illustrative purposes only, and that many other sizes and shapes of the paint roller pad storage device 100 are well within the scope of the present disclosure. Although the dimensions of the paint roller pad storage device 100 are important design parameters for user convenience, the paint roller pad storage device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint roller pad storage device that provides a user with a specialized protective bag for covering a wet paint roller pad, the paint roller pad storage device comprising:
a body component with opposing ends;
wherein the body component is configured to receive a wet paint roller pad; and
further wherein the body component is then sealed to create a generally airtight environment for storing the wet paint roller pad for additional days until further painting will occur.

2. The paint roller pad storage device of claim 1, wherein a handle is removed from a paint roller once the wet paint roller pad is retained within the paint roller pad storage device.

3. The paint roller pad storage device of claim 2, wherein the body component is a flexible, clear, plastic bag.

4. The paint roller pad storage device of claim 3, wherein the body component comprises a first end and a second end.

5. The paint roller pad storage device of claim 4, wherein the first end is open for receiving the wet paint roller pad.

6. The paint roller pad storage device of claim 5, wherein the second end is sealed closed to prevent excessive air leaks.

7. The paint roller pad storage device of claim 6, wherein the body component is generally rectilinear in shape and includes a second end with a circular closed bottom, opposite the open first end.

8. The paint roller pad storage device of claim 7, wherein the body component measures approximately 5 inches by 18 inches and has a bag volume of approximately 0.65 to 0.75 ml.

9. The paint roller pad storage device of claim 8, wherein the open first end is shaped and sized to be folded or tucked into a top of the wet paint roller pad.

10. The paint roller pad storage device of claim 8, wherein the open first end comprises a resealable closure that selectively closes the paint roller pad storage device and creates a generally airtight environment.

11. The paint roller pad storage device of claim 10, wherein the resealable closure comprises a zip-lock type closure.

12. The paint roller pad storage device of claim 11, wherein in use, the wet paint roller pad is inserted into the body component without requiring a user to touch the wet paint roller pad.

13. The paint roller pad storage device of claim 12, wherein the paint roller pad storage device is disposable and configured in a pre-packaged container with multiple bags of one size packaged together.

14. A paint roller pad storage device that provides a user with a specialized protective bag for covering a wet paint roller pad, the paint roller pad storage device comprising:
a body component that is flexible with a first end and a second end and configured to receive a wet paint roller pad;
wherein the first end is open for receiving the wet paint roller pad;
wherein the second end is sealed closed to prevent excessive air leaks;
wherein the body component is generally rectilinear in shape and the second end is a circular closed bottom;
wherein a handle is removed from a paint roller once the wet paint roller pad is retained within the body component;
wherein the open first end is shaped and sized to be folded or tucked into a top of the wet paint roller pad; and
further wherein the body component is then sealed to create a generally airtight environment for storing the wet paint roller pad for additional days until further painting will occur.

15. The paint roller pad storage device of claim 14 further comprising a plurality of indicia.

16. The paint roller pad storage device of claim 14, wherein the open first end comprises a resealable closure that selectively closes the paint roller pad storage device and creates a generally airtight environment.

17. The paint roller pad storage device of claim 16, wherein the resealable closure comprises a zip-lock type closure.

18. The paint roller pad storage device of claim 14, wherein in use, the wet paint roller pad is inserted into the body component without requiring a user to touch the wet paint roller pad.

19. The paint roller pad storage device of claim 14, wherein the paint roller pad storage device is disposable and configured in a pre-packaged container with multiple bags of one size packaged together.

20. A method of storing and protecting a wet paint roller pad for additional use, the method comprising the following steps:
providing a paint roller pad storage device comprising a body component with opposing ends, wherein one end is open and the other end is sealed closed;
opening the device and inserting a wet paint roller pad into the body component via the open end;
removing the paint roller from the wet paint roller pad;
securing the open end of the body component into the top of the wet paint roller pad, sealing the device around the paint roller pad; and
storing the device and the paint roller pad in a safe space for eventual reuse of the paint roller pad.
